(19) United States
(12) Patent Application Publication
(10) Pub. No.: US 2022/0042559 A1
(43) Pub. Date: Feb. 10, 2022

(54) Brake Disc Arrangement Having a Brake Dust Particle Filter

(71) Applicant: MANN+HUMMEL GmbH, Ludwigsburg (DE)

(72) Inventors: Lukas Bock, Bietigheim-Bissingen (DE); Thomas Jessberger, Asperg (DE); Volker Kuemmerling, Bietigheim-Bissingen (DE); Coskun Evlekli, Waiblingen (DE); Jan Corba, Chamerau (DE); Benedikt Weller, Steinheim (DE)

(21) Appl. No.: 17/510,790

(22) Filed: Oct. 26, 2021

Related U.S. Application Data
(63) Continuation of application No. PCT/EP2020/061684, filed on Apr. 28, 2020.

(30) Foreign Application Priority Data
Apr. 29, 2019 (DE) 10 2019 111 004.1

(51) Int. Cl. F16D 65/00; F16D 55/227; B01D 46/00

(52) U.S. Cl. CPC F16D 65/0031; F16D 55/227; B01D 2279/40; B01D 2265/029; B01D 46/0002

(57) ABSTRACT

A brake disc arrangement has a brake disc and a brake caliper arranged at the brake disc. A brake caliper holder is provided. One or more bearing bolts hold the brake caliper at the brake caliper holder. A brake dust particle filter is provided with a filter housing. The filter housing of the brake dust particle filter is fixedly connected by the one or more bearing bolts to the brake caliper or to the brake caliper holder.

### CROSS-REFERENCE TO RELATED APPLICATIONS

This application is a continuation application of international application No. PCT/EP2020/061684 having an international filing date of 28 Apr. 2020 and designating the United States, the international application claiming a priority date of 29 Apr. 2019 based on prior filed German patent application No. 10 2019 111 004.1, the entire contents of the aforesaid international application and the aforesaid German patent application being incorporated herein by reference.

### BACKGROUND OF THE INVENTION

The invention relates to a brake disc arrangement having a brake dust particle filter. The invention concerns moreover a brake dust particle filter for a brake disc arrangement and also a brake caliper holder-brake caliper assembly for a brake disc arrangement.

DE 10 2012 016 835 A1 discloses a brake dust receiving device for motor vehicles with which the abraded brake particles are caught which are produced during a braking action by the friction between brake disc and brake pad. The abraded brake particles are entrained by the air flow that is caused by the rotating brake disc and are caught in a brake dust particle filter that comprises a filter housing with a filter agent contained therein. The filter housing is arranged at the brake caliper of the disc brake and engages about the brake disc across an angle segment that is slightly smaller than 180°. As a filter agent, the brake dust particle filter comprises a filter medium body that, following the shape of the filter housing, has a U-shaped cross section shape and engages across the outer edge of the brake disc.

### SUMMARY OF THE INVENTION

It is the object of the invention to fasten with simple constructive measures a brake dust particle filter safely on a brake disc arrangement.

This object is solved according to the invention by a brake disc arrangement comprising a brake dust particle filter, a brake disc, and a brake caliper that is received by at least one bearing bolt at a brake caliper holder, wherein the brake dust particle filter comprises a filter housing, wherein the brake disc arrangement is characterized in that the filter housing of the brake dust particle filter is fixedly connected by the bearing bolt to the brake caliper or to the brake caliper holder.

The dependent claims provide expedient further embodiments.

The brake dust particle filter that is a component of the invention can be used in motor vehicles for receiving brake dust that is produced by friction between brake disc and brake pad upon actuation of the vehicle brake. The brake dust particle filter can be used thus in passenger cars, trucks or buses but also in agricultural or forestry vehicles and moreover can be used in other vehicles. Moreover, also a use in rail vehicles is conceivable. Finally, also a use in stationary devices is possible, for example, in shaft brakes in wind power devices.

In the mounted state, the brake dust particle filter is placed on the brake disc of a brake disc arrangement in order to receive the brake dust or abraded brake particles produced during a braking action. The brake dust particle filter comprises a filter housing as well as a filter medium body received in the filter housing that receives the brake dust. As a filter medium for the filter medium body, preferably a high temperature-resistant material is used that is stable even at a temperature of more than 600° C. in order to resist the temperatures in immediate environment of the brake disc. The filter medium can comprise a metal, metal fiber nonwoven, glass, ceramics and/or a high temperature-resistant plastic material, in particular polyether ether ketone.

Advantageously, the filter housing also comprises a sufficient temperature resistance and for this purpose is embodied, for example, of a sheet metal, for example, sheet steel.

The brake dust particle filter extends across a limited defined angle segment of the brake disc, for example, across an angle segment of 180°. Larger or smaller angle segments are also conceivable which, however, are smaller than 360° in every case. Advantageously, the segment angle across which the filter housing of the brake dust particle filter extends is at least 45°, in particular at least 90°.

The brake disc arrangement comprises in a generally known manner a brake caliper that is received in a brake caliper holder. The brake caliper holder is fixedly connected to a wheel support, for example. The connection between the brake caliper and the brake caliper holder is realized by one or a plurality of bearing bolts at which also the filter housing of the brake dust particle filter is held. The bearing bolt thus has a dual function: On the one hand, the bearing bolt serves as a connection between the brake caliper and the brake caliper holder, on the other hand, the bearing bolt is also a support of the filter housing of the brake dust filter.

This configuration has the advantage that, due to the connection of the brake dust particle filter by means of the bearing bolt or bearing bolts of the brake caliper, additional connection measures for connecting the brake dust particle filter can be eliminated. It is also advantageous that the brake dust particle filter can be substantially or completely connected and fixed independent of the brake device and the vehicle geometry so that no vehicle-specific embodiment is required; an adaptation in regard to the brake disc arrangement must only be performed instead.

The filter housing of the brake dust particle filter is preferably exclusively fastened by one or a plurality of bearing bolts between brake caliper and brake caliper holder. In a preferred embodiment, at least two bearing bolts are provided by means of which the brake caliper is received at the brake caliper holder, wherein all bearing bolts between brake caliper and brake caliper holder also serve for receiving the filter housing of the brake dust particle filter. No connection measures for connecting the brake dust particle filter to the brake disc arrangement are additionally required.

According to a further advantageous embodiment, the brake caliper is supported floatingly by the bearing bolts at the brake caliper holder. In an alternative embodiment, also a fixed non-movable connection between brake caliper and brake caliper holder is conceivable.

In case of floating support of the brake caliper at the brake caliper holder, it is advantageous that the filter housing is connected by the bearing bolt fixedly to the brake caliper and is thus supported floatingly together with the brake caliper at the brake caliper holder. In an alternative embodiment, it is also possible that the filter housing, for a floating support of the brake caliper by the bearing bolts, is fixedly connected to the brake caliper holder.

According to yet another advantageous embodiment, the filter housing is connected to an adapter part that is held at the bearing bolt. The adapter part enables a simple connection to the filter housing and, in turn, can be screw-connected to the bearing bolt or can be connected frictionally or with form fit to the bearing bolt. The adapter part is, for example, embodied in a ring segment shape to follow the curvature of the filter housing and rests against the inner side of the filter housing so that the filter housing is supported across a relatively large section at the adapter part and correspondingly is held safely at the adapter part. The adapter part is advantageously held at least at two bearing bolts wherein optionally in addition also a direct connection between the adapter part and in particular the brake caliper is conceivable.

The adapter part can comprise a U-shaped or L-shaped connecting section at its oppositely positioned ends wherein the legs of the U-shape or L-shape are connected to a respective bearing bolt. The U-shape of the connecting section of the adapter part makes it possible to engage across the brake caliper and to provide a connection at the opposite ends of each bearing bolt. It may be, for example, expedient to introduce a bearing eye into the legs of the U-shape or L-shape, respectively, with which the adapter part is pushed onto the respective bearing bolt. Advantageously, a securing element is provided at the oppositely positioned end faces of the bearing bolt in order to secure the adapter part at the bearing bolt.

In an alternative embodiment without adapter part, the filter housing is connected directly to the bearing bolt or bearing bolts.

In a further advantageous embodiment, the filter housing is connected by a clamping connection to the bearing bolts. The clamping connection enables a friction and/or form fit connection of the filter housing to the bearing bolt. Advantageously, an adapter part as a support of the filter housing can be eliminated in this embodiment. Instead, the connection and holding of the filter housing at the brake disc arrangement is realized directly at the bearing bolt by means of the clamping connection.

According to an advantageous further embodiment, the clamping connection is formed by one or a plurality of clamping elements that are connectable frictionally and/or with form fit to the bearing bolt. The clamping elements can be monolithically embodied with the filter housing. For example, conceivable is an embodiment of the clamping elements as a clamping tongue that is preferably stamped out of the filter housing. The clamping tongue engages about the bearing bolt and provides in this manner the friction and/or form fit connection with the bearing bolt. By stamping, a stamped opening in which the clamping tongue extends in the direction toward the bearing bolt is formed in the filter housing.

The clamping tongue can be embodied in a curved shape in order to facilitate engaging about the bearing bolt. The bearing bolt is located in the curved section of the clamping tongue, whereby the desired form fit connection is provided. As needed, this is also a friction connection in that the bearing bolt rests frictionally in the curved section of the clamping tongue.

According to yet another advantageous embodiment, the filter housing extends in circumferential direction completely across the brake caliper and covers thus the brake caliper. In an alternative embodiment to this, it may also be sufficient that the filter housing only partially covers the brake caliper in circumferential direction. It can be expedient that the filter housing extends across a larger angle segment than the brake caliper so that the filter housing extends past the brake caliper and covers a further angle section which adjoins the brake caliper in the rotational direction.

A further aspect of the invention concerns a brake dust particle filter for a brake disc arrangement, in particular for an afore described brake disc arrangement, wherein the filter housing of the brake dust particle filter is arranged at the bearing bolt between brake caliper holder and brake caliper.

A still further aspect of the invention concerns a brake caliper holder-brake caliper assembly for a brake disc arrangement, in particular for an afore described brake disc arrangement, wherein the brake caliper is arranged by the bearing bolt at the brake caliper holder and the bearing bolt at the same time is the support of the filter housing of the brake dust particle filter.

### BRIEF DESCRIPTION OF THE DRAWINGS

Further advantages and expedient embodiments can be taken from the additional claims, the Figure description, and the drawings.

FIG. 1 shows in perspective view a brake disc arrangement with a brake dust particle filter whose filter housing can be screwed to an adapter part which is held at bearing bolts between brake caliper and brake caliper holder.

FIG. 2 shows a partially sectioned side view of the brake disc arrangement with brake dust particle filter.

FIG. 3 shows a further perspective view of the brake disc arrangement with the brake dust particle filter.

FIGS. 4, 5, and 6 show a brake disc arrangement with a brake dust particle filter in a further embodiment variant.

In the Figures, same components are provided with the same reference characters.

### DESCRIPTION OF PREFERRED EMBODIMENTS

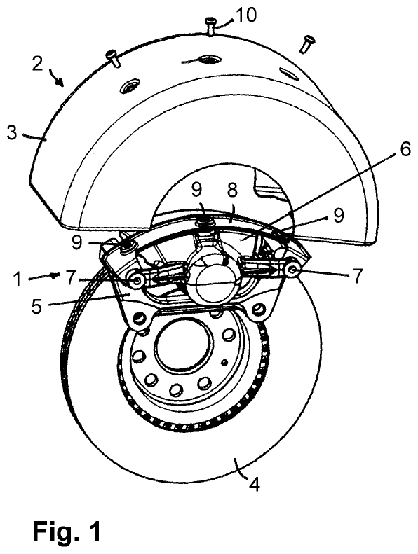

In FIGS. 1 to 3, in a first embodiment variant a brake disc arrangement 1 is illustrated that is typically used in motor vehicles. The brake disc arrangement 1 is provided with a brake dust particle filter 2 that comprises a filter housing 3 which is placed onto a brake disc 4 of the brake disc arrangement 1. The filter housing 3 accommodates a filter medium body in which brake dust is collected which is produced by friction during a braking action.

The brake disc arrangement 1 comprises in addition to the brake disc 4 a brake caliper holder 5 and a brake caliper 6 that is a carrier of brake pads which contact the brake disc 4 during a braking action. The brake caliper 6 is floatingly supported at the brake caliper holder 5 which is, for example, arranged at a wheel support. The floating support of the brake caliper 6 enables a relative movement of the brake caliper 6 relative to the brake caliper holder 5 in axial direction, in relation to the longitudinal axis of the brake disc 4. The floating support of the brake caliper 6 is achieved by means of bearing bolts 7 which extend parallel to the longitudinal axis of the brake disc 4 and are received in correlated cutouts in the brake caliper holder 5. Distributed about the circumference, a total of two bearing bolts 7 are arranged at oppositely positioned ends of brake caliper holder 5 and brake caliper 6.

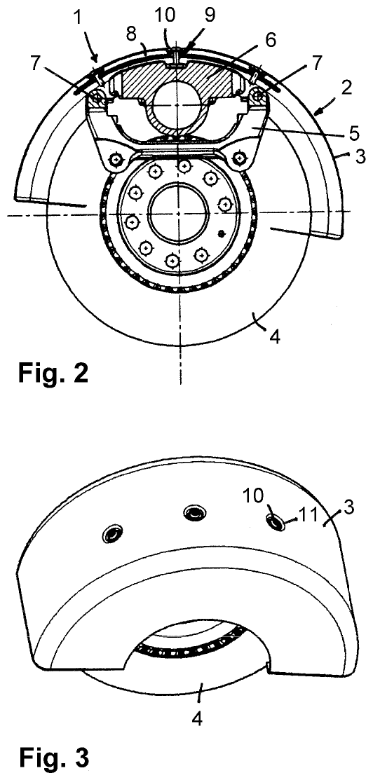

The brake dust particle filter 2 is held by the brake caliper 6. For this purpose, the filter housing 3 of the brake dust particle filter 2 is screw-connected to an adapter part 8 that is fastened at the brake caliper 6. The adapter part 8 is embodied in a ring segment shape and extends concentrically to the circumferential side of the brake disc 4 at a radial distance to the circumferential side. The adapter part 8 comprises a total of three screw sleeves 9 distributed across its length—in relation to the circumferential direction—into which screws 10 can be screwed which can be inserted through openings 11 in the curved outer wall of the filter housing 3. The curved outer wall of the filter housing 3 is positioned in the mounted state also concentrically to the outer contour of the brake disc 4 so that the curved adapter part 8 and the inner side of the outer wall of the filter housing at which the adapter part 8 is resting extend also concentrically to each other (FIG. 2), wherein the inner side of the outer wall is supported advantageously at the adapter part 8. By being screw-connected to the adapter part 8, the filter housing 3 is fixedly connected to the brake caliper 6 so that, due to the floating support of the brake caliper 6 at the brake caliper holder 5, the brake dust particle filter 2 also carries out the floating movement of the brake caliper 6.

The adapter part 8 extends in circumferential direction across the same length as the brake caliper 6. The adapter part 8 comprises at both circumferential ends a respective U-shaped connecting section with laterally folded-down legs into which a bearing eye is introduced, respectively, through which the bearing bolt 7 is passed. The bearing bolt 7 at one end can be provided with a head wherein at the other end a securing element is arranged at the bearing bolt 7 in order to secure the bearing bolt 7 in its position for securing and holding brake caliper 6 as well as adapter part 8 at the brake caliper holder 5.

The total of three screw sleeves 9 at the adapter part 8 are distributed across the length of the adapter part. The two outwardly positioned screw sleeves 9 are positioned at or adjacent to the U-shaped connecting section at the respective end face end of the adapter part 8. The third screw sleeve 9 is located at the center of the adapter part 8. Immediately below the central screw sleeve 9 a recess is introduced in the brake caliper 6, as can be taken from FIG. 2, that enables an unhindered screwing in of the screw 10 into the central screw sleeve 9, wherein the tip of the screw projects through the screw sleeve 9 and the adapter part 8. The screw sleeve 9 comprises a radial extension while the length axis of the bearing bolts 7 is parallel to the axis of rotation of the brake disc 4.

The filter housing 3 forms a segment-shaped hood that extends about 180° wherein two parallel sidewalls are arranged at the curved outer wall. As a whole, the filter housing 3 forms a semi-annular shape that is closed to the exterior and to the sides but is open inwardly in order to enable placement on the brake disc 4.

The filter housing 3 extends across a larger angle segment than the brake caliper 6 and engages completely across the brake caliper 6 in circumferential direction. As can be taken from FIG. 2, the filter housing 3 is arranged slightly pivoted by a small angle amount of 5° to 10° in relation to the symmetry axis of the brake caliper 6. Due to this asymmetric positioning of the filter housing 3 in relation to the brake caliper 6, the filter housing 3 extends with sections of different size to the left and to the right of the brake caliper 6. Advantageously, the larger section of the filter housing 3 is located at the brake caliper 6 at the downstream side in relation to the rotational direction of the brake disc 4.

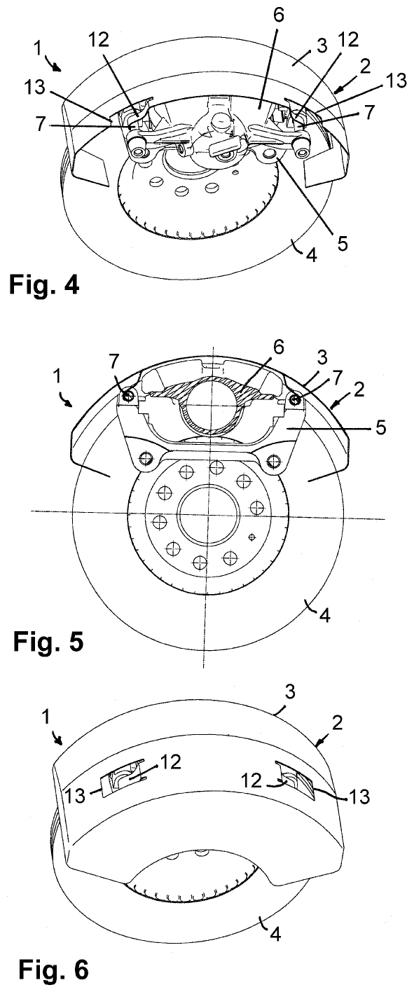

In FIGS. 4 to 6, a further embodiment of a brake disc arrangement 1 with a brake dust particle filter 2 is illustrated. The basic configuration corresponds to that of the first embodiment according to FIGS. 1 to 3. In the second embodiment according to FIGS. 4 to 6, an adapter part for connection of the filter housing 3 to the brake disc arrangement 1 is eliminated, however. Instead, the connection of the filter housing 3 to the brake disc arrangement 1 is realized by clamping tongues 12 that form clamping elements and are arranged at the filter housing 3. The clamping tongues 12 are monolithically formed with the filter housing 3 and are produced in the ring-shaped section of the filter housing 3 by stamping. In this way, in the ring-shaped section of the filter housing 3, a stamped opening 13 is formed in which the clamping tongue 12 extends radially inwardly in the direction toward the bearing bolt 7 which is engaged about by a curved section of the clamping tongue 12. In this way, a form fit and friction connection can be produced.

The curved sections of the clamping tongues 12 are oriented away from each other. In the mounted state, each bearing bolt 7 is engaged about by the clamping tongues 12 in circumferential direction at the outwardly positioned side—viewed from a central position between the bearing bolts 7. In this way, a form fit securing of the filter housing 3 at the bearing bolts 7 is ensured in circumferential direction.

What is claimed is:

1. A brake disc arrangement comprising:
a brake disc;
a brake caliper arranged at the brake disc;
a brake caliper holder;
one or more bearing bolts holding the brake caliper at the brake caliper holder;
a brake dust particle filter comprising a filter housing;
wherein the filter housing of the brake dust particle filter is fixedly connected by the one or more bearing bolts to the brake caliper or to the brake caliper holder.

2. The brake disc arrangement according to claim 1, wherein the brake caliper is supported floatingly at the brake caliper holder by the one or more bearing bolts.

3. The brake disc arrangement according to claim 1, further comprising an adapter part configured as a support of the filter housing, wherein the adapter part is held at the one or more bearing bolts.

4. The brake disc arrangement according to claim 3, wherein the filter housing is screw-connected to the adapter part.

5. The brake disc arrangement according to claim 3, wherein the adapter part comprises opposed ends and the opposed ends comprise a U-shaped or L-shaped connecting section, respectively, wherein the U-shaped or L-shaped connecting section comprises legs and the legs are connected to one of the one or more bearing bolts, respectively.

6. The brake disc arrangement according to claim 5, wherein the legs comprise bearing eyes configured to receive said one of the one or more bearing bolts.

7. The brake disc arrangement according to claim 3, wherein the adapter part comprises a ring-segment shape.

8. The brake disc arrangement according to claim 1, wherein the filter housing is connected by a clamping connection to the one or more bearing bolts.

9. The brake disc arrangement according to claim 8, wherein the filter housing comprises one or more clamping elements forming the clamping connection, wherein the one or more clamping elements are configured to connect frictionally and/or with form fit to the one or more bearing bolts.

10. The brake disc arrangement according to claim 9, wherein the one or more clamping elements each is a clamping tongue, wherein the clamping tongue is formed monolithically together with the filter housing.

11. The brake disc arrangement according to claim 1, wherein the filter housing completely covers the brake caliper in a circumferential direction thereof.

12. A brake dust particle filter for a brake disc arrangement that comprises a brake disc, a brake caliper arranged at the brake disc, a brake caliper holder, and one or more bearing bolts holding the brake caliper at the brake caliper holder; the brake dust particle filter comprising:
a filter housing configured to be fixedly connected by the one or more bearing bolts, holding the brake caliper at the brake caliper holder, to the brake caliper or to the brake caliper holder.

13. An assembly comprising:
a brake caliper configured to be arranged at a brake disc;
a brake caliper holder;
one or more bearing bolts holding the brake caliper at the brake caliper holder;
a filter housing of a brake dust particle filter fixedly connected by the one or more bearing bolts, holding the brake caliper at the brake caliper holder, to the brake caliper or to the brake caliper holder.
